(19) United States
(12) Patent Application Publication
(10) Pub. No.: US 2022/0324503 A1
(43) Pub. Date: Oct. 13, 2022

(54) A CARRIAGE FOR TRANSPORTING A CHILD OR INFANT

(71) Applicant: EBITSU LTD., Knutsford (GB)

(72) Inventors: Louise Catherine Sanders, Knutsford (GB); Matthew William Sanders, Knutsford (GB)

(21) Appl. No.: 17/640,577

(22) PCT Filed: Sep. 4, 2020
(86) PCT No.: PCT/GB2020/052123

§ 371 Date: Mar. 4, 2022

(30) Foreign Application Priority Data
Sep. 5, 2019 (GB) 1912768.7

(51) Int. Cl. B62B 9/14; B62B 7/14; B62B 9/12

(52) U.S. Cl. CPC B62B 9/14; B62B 7/145; B62B 9/12

(57) ABSTRACT

A carriage for transporting a child comprising: a chassis; a plurality of ground bearing wheels; a detachable cradle for supporting a child; a system for controlling environmental conditions within the cradle, the system having at least one electrical component for altering an environmental condition disposed on or in the cradle and at least one input means for controlling the or each electrical component disposed on or in the chassis. In the first aspect the carriage comprises a connector assembly for detachably mounting the cradle in different configurations wherein the cradle faces away from, or toward, a carriage operator, the connector and co-locating connector providing an electrical connection between the or each electrical component and the control panel in either configuration. In a second aspect, the canopy is movable by an electric motor. In a third aspect, the cradle is pivotable between a reclined and inclined position.

This invention relates generally to a carriage for transporting a child or infant.

### BACKGROUND TO THE INVENTION

Carriages, such as pushchairs, prams and strollers, are used to transport infants or young children from place to place. During transport, the infant or child can be exposed to adverse environmental conditions, such as sun, wind, rain, exhaust fumes and other contaminates, and noise. To address some adverse environmental conditions there have been a number of developments including modifications to the carriage or the inclusion of aftermarket add-ons. For example, deployable covers have been included in the design of the baby carriage or sold as separate addons to help protect against rain.

These covers have been designed to be deployed quickly and as such tend to be thin foldable materials which may be stored without taking up much room or adding much weight. One example of a deployable cover is a separate sheet of waterproof material designed to be fitted around the carriage to protect the infant or child from rain. Another example is a component attached to the chassis which allows for the cover to be moved into a deployed position, such as a series of movable rigid ribs onto which the thin flexible material is attached. Both types of deployable covers can be easily damaged due to the thin flexible material used.

A major concern for parents is infants and children being exposed to air contaminants, such as pollution from motor-vehicle exhaust fumes, while being transported, for example, to school on pavements next to busy roads within baby carriages. This can be damaging to developing lungs, particularly as the heavier particles within the pollution tend to be at exhaust height, around the height from the ground of an infant within a baby carriage. While solutions have been proposed they do not adequately address the issue.

By providing auditory stimulus to an infant or child it is possible to help keep them entertained and maintain their focus so as not to be fretful or unhappy. There have also been links made with auditory stimulus helping development. This has led to the development of aftermarket speaker systems usable with carriages. However, as these are separate devices the various components have to be attached and may be placed in inappropriate positions for the level of sound produced. Furthermore, the wiring can lessen the aesthetic appeal of the baby carrier, create a potential hazard for the infant, impedes components of the baby carrier and be an obstacle to the parent or caregiver.

There are a number of schools of thought in relation to visual stimulus that a parent, or caregiver, can consider when deciding on the most appropriate baby carriage. The baby carriage can be constructed so that the infant or child faces the person, be it parent or caregiver, operating the baby carriage, this is known as ‘parent-facing’. Alternatively, the baby carriage can be constructed so that the infant or child faces in the opposite direction to the parent or caregiver, this is known as ‘world-facing’. Carriages which are convertible between both configurations have been developed. However, a problem arises in providing power and control signals to components in the cradle and in the chassis between configurations.

The cradle tends to be designed for a particular age range. For example, a bassinet type carrier may be used for young infants as they may not be able to sit up unaided for long periods or have good control of their head; for later stages of development, an adjustable chair which allows for an upright sitting position is recommended. Carriages convertible between a bassinet type and adjustable chair type cradles have been developed. However, they usually require a separate module for the bassinet and chair. These separate modules can be cumbersome to transport and store, are a costly extra.

It is an object of the present invention to reduce or substantially obviate the aforementioned problems.

### STATEMENT OF INVENTION

A first aspect of the present invention is provided by a carriage for transporting a child or infant comprising a chassis; a plurality of ground bearing wheels; a detachable cradle for supporting a child; a system for controlling environmental conditions within the cradle, the system having an electrical component for altering an environmental condition disposed on or in the cradle and a control interface for controlling the electrical component disposed on or in the chassis; and a connector assembly for detachably mounting the cradle to the chassis in a first configuration in which the cradle faces away from the carriage operator and a second configuration in which the cradle faces towards the carriage operator, the connector assembly having a connector disposed on or in the cradle and co-locating connector disposed on or in the chassis, the connector and co-locating connector providing an electrical connection between the electrical component and the control interface in either configuration.

Advantageously, the carriage ensures that the environmental conditions, such as auditory stimulus, UV exposure, pollutants, or other electrical components, can be conveniently controlled in either configuration of the cradle, because the connector assembly is reversible which provides an electrical connection in both configurations.

Furthermore, the connector assembly allows for the detachable cradle to be swapped or replaced with another cradle comprising a substantially same or similar connector of the connector assembly. This allows for the carriage to use multiple types of cradles, such as lay-flat types or sit-up types which can incorporate controllable devices. The connector assembly provides a way to automatically connect controllable devices to a control interface and/or power source during mounting of the detachable cradle.

The system for controlling environmental conditions may comprise at least one or more of the following: a protective canopy formed from a plurality of rigid segments, the canopy being movable by an electric motor between an open configuration and a closed configuration; an air ventilation system comprising at least one ventilation unit for supplying filtered air to the cradle; and a speaker system connectable to an external signal source.

Further protective canopies may be provided.

A fabric canopy may be provided. The fabric canopy may be manually operated by a carriage operator. The Fabric canopy may be movable from a stowed configuration to a deployed configuration.

The co-locating connector may be adapted to support the weight of the cradle through the connector.

The carriage may include two connector assemblies disposed on a horizontal axis. The connector assemblies may be on the opposite sides of the carriage. The connector assemblies are reversible so that the connector of a first connector assembly on one side of the carriage can be received in both the co-locating connector of the first connector assembly and the co-locating connector of a second connector assembly on the other side of the carriage and vice versa.

The co-locating connector may include a stationary element disposed on or in the chassis and a rotatable element disposed on the stationary element.

The rotatable element may include a recess for receiving an element of the connector, the recess may be provided in a wall. A wall of the rotatable element may include a bearing portion for bearing against a portion of the connector. The bearing portion may be a significant portion of the wall. A plurality of recesses may be provided. The recess may be a slot, or aperture.

The bearing portion may be recessed for receiving a portion of the connector and the recess for receiving an element of the connector may be provided in the recess for receiving a portion of the connector.

The connector may include a wall for interfacing with a bearing portion of the co-locating connector. The connector may comprise an element for, in use, being received in a recess of the co-locating connector. A plurality of elements may be provided. The or each element may extend from a wall of the connector. The wall and bearing portion support the cradle.

In use, the element(s) of the connector may be received by the recess(es).

A first set of conductive contacts may be disposed on or in the connector. A second set of conductive contacts may be disposed on or in the co-locating connector. Each conductive contact of the first set of conductive contacts correspond with a conductive contact in the second set of conductive contacts.

The second set of conductive contacts may be disposed on or in a recess or wall of the co-locating connector. The first set of conductive contacts may be disposed on or in an element or a wall of the connector.

The first set of conductive contacts may provide an electrically conductive connection to components disposed in or on the cradle. The second set of conductive contacts may provide an electrically conductive connection to at least one of an input means, control interfaces and/or power sources disposed in or on the chassis.

The first set of conductive contacts may be disposed on or in a surface of the connector. The first set of conductive contacts may extend from a surface of the connector of the connector assembly. The first set of conductive contacts may be conductive rings, pads, brushes or pins.

Preferably, the first set of conductive contacts may comprise a plurality of conductive pins disposed on or in the wall of the connector. More preferably, the first set of conductive contacts may comprise eight pins.

The second set of conductive contacts may be disposed in or on a surface of the co-locating connector. The second set of conductive contacts may be disposed in a recess of the co-locating connector. The second set of conductive contacts may extend from a surface of the co-locating connector. The second set of conductive contacts may be disposed on the element of the co-locating connector.

The second set of conductive contacts may be conductive rings, pads, brushes or pins.

Preferably, the second set of conductive contacts may be a plurality of conductive pads disposed on or in the wall of the co-locating connector. More preferably, the second set of conductive contacts may comprise eight pads.

Either or both of the first set of conductive contacts and/or the second set of conductive contacts may be biased. For example, each conductive contact may be spring-loaded. Biasing the conductive contacts ensure that an electrical connection is established and maintained when the detachable cradle is fitted to the carriage.

The carriage may comprise a cradle inclining and reclining means. The cradle inclining and reclining means maybe disposed in or on the cradle and/or on or in the chassis.

The cradle inclining and reclining means may comprise an electrical motor for rotating the cradle about the horizontal axis. The electrical motor may be connected to and controlled from the control interface. The electrical motor may be disposed in the connector and/or co-locating connector.

The electrical motor of the inclining and reclining means may include a spindle and be disposed in the chassis. The spindle may be coupled to the rotatable element of the co-locating connector. The spindle may be fixedly coupled or may be coupled by a transmission means. The transmission means may be gearing.

At least one power source may be disposed on or in the chassis or cradle. A power source may be disposed in the co-locating connector or the connector. A first power source may be disposed in a first co-locating connector or a first connector and a second power source may be disposed in a second co-locating connector or a second connector.

The cradle inclining and reclining means provides the cradle with the ability to rotate about a horizontal axis allowing for a first substantially horizontal configuration, like a pram, to a second configuration angled from the horizontal to provide an inclined position, like a pushchair.

The carriage may comprise a canopy opening and closing means.

The canopy opening and closing means may comprise an electrical motor for moving the canopy. The canopy opening and closing means may include a transmission means such as a series of gears.

The electrical motor may be disposed in the connector and/or co-locating connector. The electrical motor may be disposed in the cradle.

The canopy opening and closing means allows the canopy to be moved through a series of configurations between an open configuration and a closed configuration. Furthermore, by providing an electrical connection, preferably through a connector assembly, it is possible to deploy the canopy with a touch of a button.

The protective canopy in the closed configuration may substantially cover at least two thirds of the cradle and in the open configuration substantially cover one third or less of the cradle.

In the closed configuration, the protective canopy may seal an opening for receiving the child or infant in the cradle. In the open configuration, the protective canopy may retract into the cradle or only extend partially over an opening for receiving the child or infant in the cradle.

The cradle may be formed from a rigid rim surrounding a cavity for receiving the baby and a curved rigid wall extending from the rigid rim, the cavity having a first region for receiving, in use, the head of the baby.

The ventilation unit may comprise an air duct having an inlet and outlet, a replaceable filter disposed in the air duct or in the inlet or outlet, and a ventilation fan to draw air into the cavity through the filter and air duct; wherein the outlet for the air duct is located in the first region.

By providing a ventilation unit it is possible to improve the air quality within the cradle. Furthermore, by directing the flow of filtered air over the child or infants head it is not necessary to seal the cradle to improve air quality.

The protective canopy in its closed configuration may substantially block the inlet of the ventilation unit.

The speaker system may comprise a speaker located in the first region of the cavity.

The speaker system may have a limiter for limiting the decibel level of the sound produced by the speakers. The limiter being set to limit the decibel level in the first region to a predetermined level.

A speaker provides a means to control the auditory stimulus provided to the baby. The limiter ensures the babies hearing cannot be accidently damaged.

Each of the segments of the protective canopy may be made from a rigid material such as polycarbonate or acrylic, IUPAC ID poly(methyl 2-methylpropenoate).

Rigid canopies are less easily damaged by ripping, provide protection against wind, rain and dropped items. Furthermore, they improve the aesthetics of the carriage.

The protective canopy may be an ultraviolet protective canopy for filtering electromagnetic radiation with a wavelength between approximately 100 nm and approximately 400 nm, more particularly ultraviolet radiation in the UVA and UVB bands, i.e. between approximately 280 nm and approximately 400 nm.

The material of the ultraviolet protective canopy may include ultraviolet light absorbing compounds.

An ultraviolet filtering film may be applied to each of the segments of the ultraviolet protective canopy.

An ultraviolet filter coating may be applied to each of the segments of the ultraviolet protective canopy.

By providing UV protection it is possible to limit or remove damaging electromagnetic radiation.

The protective canopy may be substantially tinted to reduce the percentage of light transmitted through the protective canopy. The tinting may be provided by a film or compound added to the material of the protective canopy.

The protective canopy may be substantially clear.

The protective canopy may be waterproof when in a closed configuration.

The protective canopy in the closed configuration may substantially cover at least two thirds of the cradle and in the open configuration substantially cover one third or less of the cradle.

The carriage may further comprise an extendable handle. The control interface may be disposed on or in the extendable handle.

An extendable handle provides a means to easily adjust the height of the handle.

The control interface may have a plurality of input means, for example switches or buttons, disposed on the chassis.

The control interface may be a touch screen.

The chassis may comprise a first set of lights for illuminating an area in front of the operator and a second set of lights illuminating an area behind the operator.

The first and/or second sets of lights may be controllable by the control interface. The level of illumination provided by both the first and/or second sets may be controllable.

The inclusion of lights can improve safety as it allows the person operating the carriage to better view the environment and for others to be aware of the carriage.

The control interface and/or speaker system may comprise a wireless module for connecting to an external device. The wireless module may receive data and instructions from the external device. For example, the wireless module may receive audio data from a mobile device through Bluetooth®.

The wireless connection means ensures that there are no wires outside the chassis which improves safety and aesthetic appeal.

The cradle may comprise at least one removable insert for providing support to the child or infant in a seated position or a prone position.

The chassis may be foldable.

A second aspect of the present invention is provided by a carriage for transporting a child or infant comprising a chassis, a plurality of ground bearing wheels, a detachable cradle for supporting a child, the cradle including a protective canopy formed from a plurality of rigid segments, the canopy being movable between an open configuration and a closed configuration, and a system for controlling environmental conditions within the cradle, the system having at least one electrical component for altering an environmental condition disposed on or in the cradle and an input means for controlling the or each controllable component disposed on or in the chassis, wherein the system includes a canopy actuating means, the canopy actuating means comprising an electric motor for moving the protective canopy between the open configuration and the closed configuration, the electric motor including a rotatable spindle coupled to at least one of the segments.

Advantageously, a carriage with powered actuation of the canopy allows for the cradle to be quickly and easily closed or opened in response to external conditions, such as rain, sunlight, or exhaust gases, which ensure that the conditions within the cradle can be easily controlled. Moreover, a carriage with a rigid canopy can easily maintain its aesthetics while increasing protection.

In the second aspect, the carriage may further comprise a connector assembly comprising a connector disposed in or on the cradle and a co-locating connector disposed in or on the chassis.

The canopy actuating means may include the same features as the canopy opening and closing means discussed.

The canopy actuating means may comprise a coupling assembly to couple the motor to the canopy. The motor may be coupled to the protective canopy by a transmission, such as a series of gears. The transmission may be coupled to each segment and move each segment at a different rate. The transmission may be considered the coupling assembly.

Each segment of the canopy may have a gear of the transmission disposed thereon.

The coupling assembly, such as a transmission, may comprise a first set of gears disposed on a first axle and a second set of gears disposed on a second axle. The second set of gears may rotate about the second axle. Each segment of the canopy may rotate about the second axle.

A plurality of gear pairs may be provided by each gear of the first set engaging with a gear of the second set. Each gear of the second set is disposed on a corresponding segment of the canopy. An electric motor may drive the first set of gears which in turn drives the second set of gears. Each gear pair may have a different gear ratio. The plurality of segments may be partially nested in the open configuration.

The segments may comprise a coupling assembly for coupling the rotational movement of one segment to another segment.

The coupling assembly, as an alternative to or in combination with the above, may comprise a pin receiving slot for receiving a pin of another segment's coupling assembly and a pin for being received in the pin receiving aperture of another segment's coupling assembly.

A third aspect of the present invention is provided by a carriage for transporting a child or infant comprising a chassis, a plurality of ground bearing wheels, a detachable cradle for supporting a child, the detachable cradle having a horizontal axis located on a plane substantially bisecting the cradle, and a cradle rotating means for rotating the cradle about the horizontal axis, the cradle rotating means comprising an electric motor connectable to an input disposed on or in the chassis, wherein the cradle rotating means rotates the cradle between a first or reclined configuration in which the cradle is substantially horizontal and a second or inclined configuration in which the cradle is angled by less than 90 degrees from horizontal.

Advantageously, a cradle with a motorised means of inclining or reclining the cradle allows for a change between configurations to effected quickly and easily as it simplifies the process.

The inclined angle may be limited to approximately 45 degrees from horizontal.

The cradle rotating means may comprise the same features as the cradle incline and reclining means discussed.

In the third aspect, the carriage may further comprise a connector assembly comprising a connector disposed in or on the cradle along the horizontal axis and a co-locating connector disposed in or on the chassis.

The electric motor may be disposed in the connector of the connector assembly.

The electric motor may be disposed in the co-locating connector of the connector assembly.

The cradle rotating means may comprise a transmission for coupling the rotation of the electric motor to the cradle.

In the third aspect, the carriage may further comprise a system for controlling environmental conditions within the cradle, the system having at least one electrical component for altering an environmental condition disposed on or in the cradle and an input means for controlling the or each controllable component disposed on or in the chassis.

One segment of the plurality of segments may be driven by the electric motor, wherein the driven segment in turn drives at least some of the remaining segments.

A fourth aspect of the present invention is provided by a carriage for transporting a child, the carriage comprising a chassis, a plurality of ground bearing wheels disposed on the chassis, a detachable cradle for supporting a child, a system for controlling environmental conditions within the cradle, the system having at least one controllable component for altering an environmental condition disposed on or in the cradle and a control interface for controlling the or each controllable component, the control interface being disposed on or in the chassis, and a connector assembly for detachably mounting the cradle to the chassis, the connector assembly having a connector disposed on or in the cradle and co-locating connector disposed on or in the chassis, the connector and co-locating connector providing an electrical connection between the or each controllable component and the control interface.

The fourth aspect of the present invention may share at least some of the features of the first, second and/or third aspects of the present invention.

A fifth aspect of the present invention is provided by a cradle for detachably mounting to a carriage for transporting a child or infant. The cradle comprises a controllable component for altering an environmental condition disposed on or in the cradle, and a connector disposed on or in the cradle, the connector being adapted to connect with a co-locating connector disposed on or in the carriage, wherein the controllable component is connectable to a control interface disposed on or in the carriage through connection of the connector and the co-locating connector.

The connector of the fifth aspect of the present invention may share at least some of the features of the connector of the connector assembly of the first, second, third and/or fourth aspects of the present invention.

The cradle of the fifth aspect of the present invention may share at least some of the features of the cradle of the first, second, third and/or fourth aspects of the present invention.

A sixth aspect of the present invention is provided by a carriage for transporting a child or infant. The carriage comprises a chassis, a plurality of ground bearing wheels mounted to the chassis, a control interface disposed on or in the chassis for controlling controllable components disposed on or in a mountable cradle, and a co-locating connector disposed on or in the chassis, the co-locating connector being adapted to connect with a connector disposed on or in a cradle, wherein the control interface is connectable to the controllable components through connection of the co-locating connector and the connector.

The co-locating connector of the sixth aspect of the present invention may share at least some features of the co-locating connector of the connector assembly of the first, second, third and/or fourth aspects of the present invention.

The chassis of the sixth aspect of the present invention may share at least some features of the chassis of the first, second, third and/or fourth aspects of the present invention.

The carriage of the sixth aspect of the present invention may share at least some features of the carriage of the first, second, third and/or fourth aspects of the present invention.

A kit of parts may comprise the fifth aspect of the present invention and the sixth aspect of the present invention.

The canopy opening and closing means, also referred to as the canopy actuating means, may be considered a canopy actuating assembly.

The canopy opening and closing means, also referred to as the canopy actuating means, may cause each segment of the protective canopy to rotate about a substantially horizontal axis.

The axis on which each segment of the protective canopy rotates may be offset from the axis on which the cradle rotates.

Cradle rotating means may also be known as the cradle incline and reclining means.

Electrical components should be considered controllable components and may include electronic components.

### BRIEF DESCRIPTION OF THE DRAWINGS

For a better understanding of the present invention, and to show more clearly how it may be carried into effect, reference will now be made by way of example only to the accompanying drawings, in which:

FIG. 1 shows a perspective view of a carriage for an infant or child according to an embodiment of the invention;

FIG. 2a shows a view of the carriage in FIG. 1 in which the cradle is in a world-facing configuration;

FIG. 2b shows a view of the carriage in FIG. 1 in which the cradle is in a parent-facing configuration;

FIG. 3a shows a view of the carriage in FIG. 1 in which the cradle is in an inclined world-facing configuration;

FIG. 3b shows a view of the carriage in FIG. 1 in which the cradle is in an inclined parent-facing configuration;

FIG. 4a shows a view of the coupling assembly for a segment of a canopy according to an embodiment of the invention;

FIG. 4b shows a view of two segments of the canopy coupled by the coupling assembly;

FIG. 4c shows a further view of the two segments of the canopy coupled in FIG. 4b;

FIGS. 5a and 5b shows a view of a connector assembly according to an embodiment of the invention;

FIG. 6 shows a view of a carriage for an infant or child according to an embodiment of the present invention;

FIG. 7 shows a view of the carriage in FIG. 6 with the cradle detached from the chassis;

FIG. 8a shows a view of the carriage in FIG. 6 with the canopy in an open configuration;

FIG. 8b shows a view of the carriage in FIG. 6 with the canopy in a closed configuration;

FIG. 9 shows a cross section of the cradle with a removable insert according to an embodiment of the invention;

FIG. 10 shows a cross section of the cradle with a removable insert according to an embodiment of the invention;

FIG. 11 shows a perspective view of a connector assembly according to an embodiment of the invention;

FIG. 12 shows a cross-sectional view of the connector assembly shown in FIG. 11; and

FIG. 13 shows a schematic view of a canopy actuating means.

### DESCRIPTION OF PREFERRED EMBODIMENTS

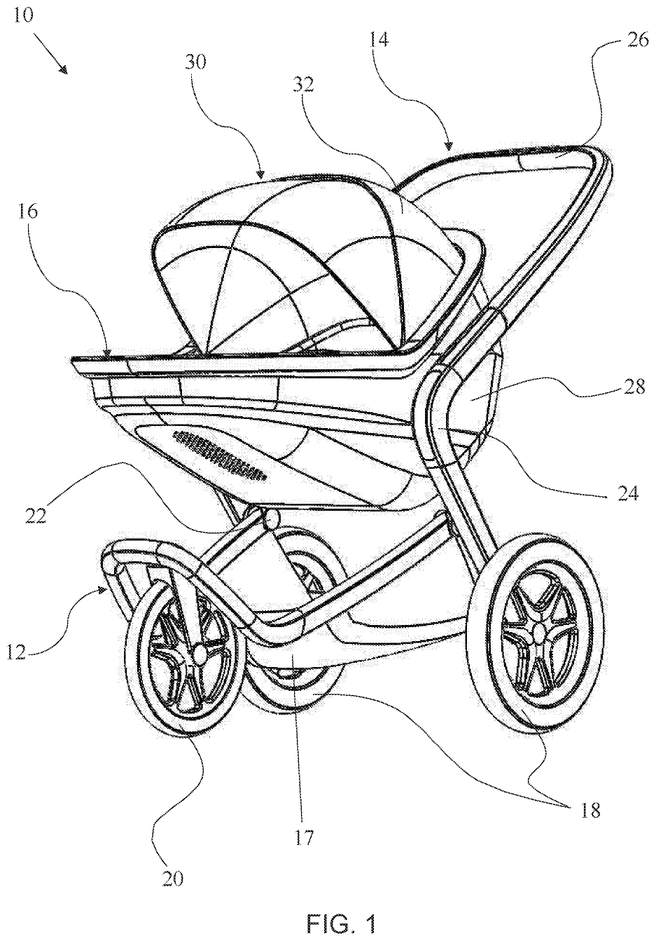

Referring firstly to FIGS. 1, 2a, 2b, 3a and 3b, a carriage for a baby or child is generally indicated at 10.

FIGS. 1, 2a, 2b, 3a and 3b show a first embodiment of a carriage 10 for a child or infant. The carriage 10 comprises a foldable chassis formed from a front-frame section 12 and a rear-frame section 14, a plurality of ground bearing wheels coupled to the chassis, a detachable cradle 16 and a storage tray 17. In the current embodiment, there are two fixed wheels 18 connected to the rear-frame section 14 and a caster wheel 20 connected to the front-frame section 12.

The front-frame section 12 is generally a forked section formed by two prongs connected to the rear-frame section 14 by a pivoting means 22. In the current embodiment, each pivoting means is provided by a pin extending from the surface of the rear-frame section 14, the pin extends through a bore in the prong. The pivoting means is also provided with a locking element to lock the front-frame section in a folded configuration or an unfolded configuration.

The rear-frame section 14 is generally formed from two frame elements extending from a connection point with the fixed wheels 18 to a cradle connection section 24 and an extendable handle section 26 extending from the cradle connection section 24. The extendable handle section 26 comprises a first frame element which is approximately horizontal and two second frame elements extending at an angle from the ends of the first frame element. The second frame elements may be lockable telescopic frame elements.

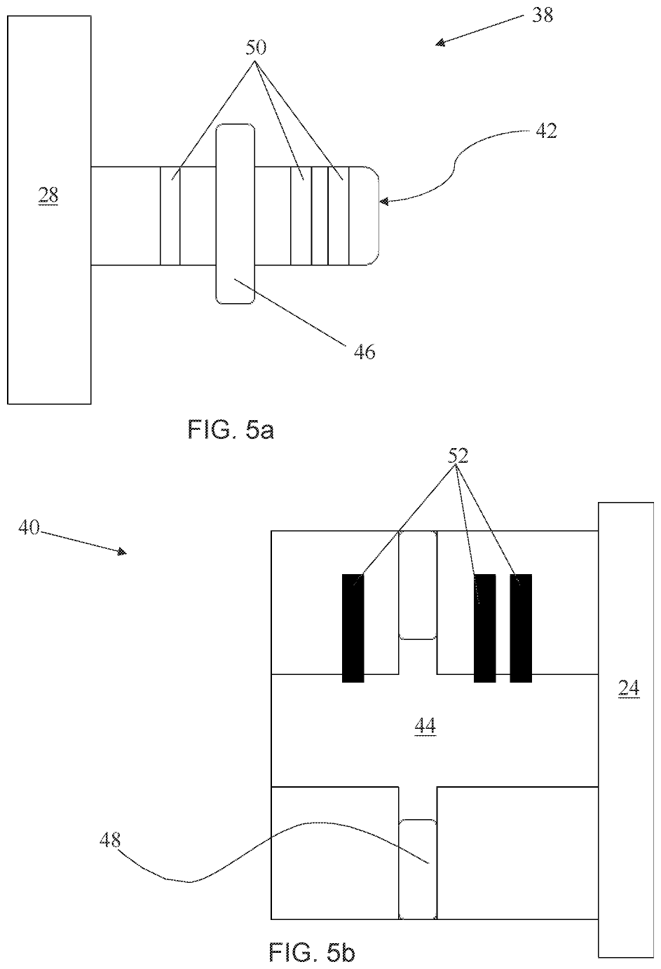

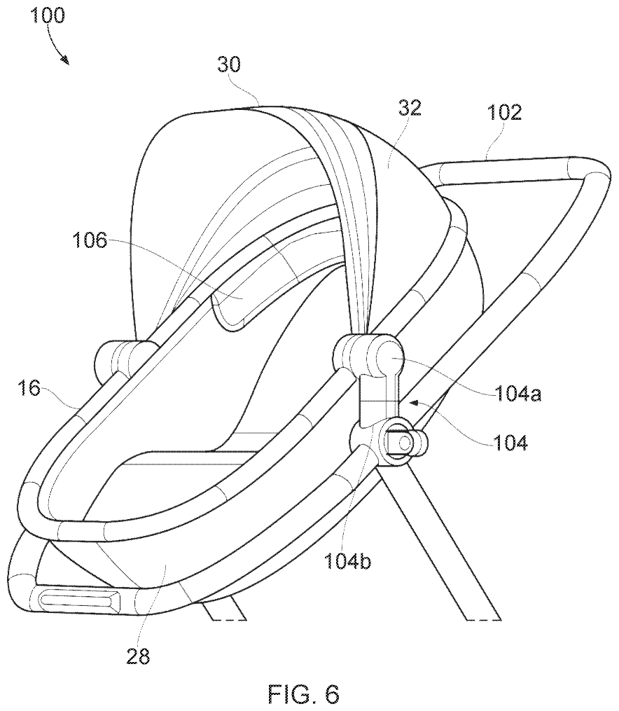

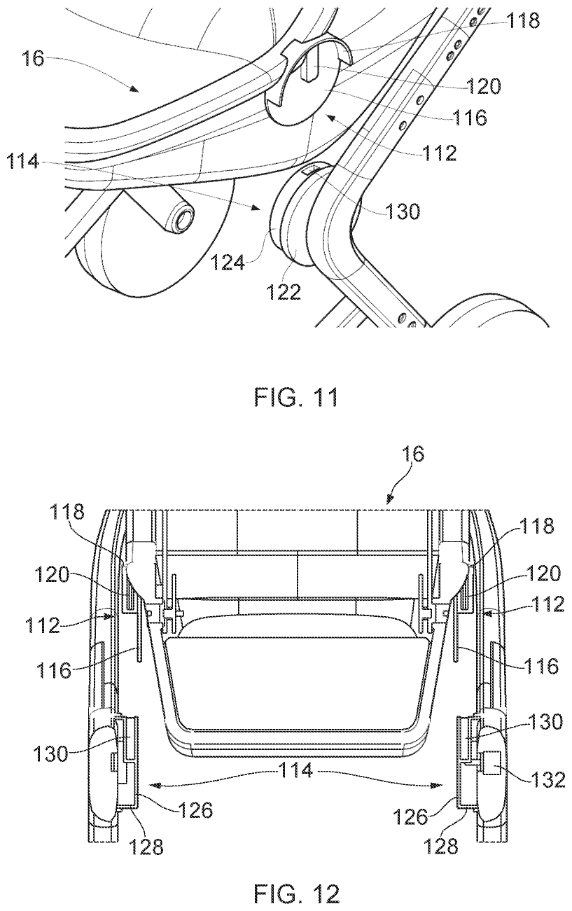

The detachable cradle 16 comprises a rigid body 28 defining a cavity for receiving a child or infant, a rigid canopy 30 for covering the cavity and a frame connection means (for example, 38 in FIG. 5a or 112, 114 in FIGS. 11 and 12) for detachably connecting the cradle 16 to the cradle connection section 26. The rigid canopy 30 is movable between an open configuration in which the cavity is accessible through an aperture in the rigid body and a closed configuration in which the cavity is not accessible through the aperture in the rigid body.

In some embodiments, the cradle 16 may include a system for controlling electrical components which can alter environmental conditions within the cavity, such as the level of UV, the type of auditory stimulus present or the quality of air.

In some embodiments, a speaker system is provided in the cavity which is wirelessly connectable, for example through Bluetooth, to an external device adapted to provide an audio signal and/or instructions.

In some embodiments, there may be a ventilation system with a plurality of ventilation units. Each ventilation unit includes a fan and a filter disposed in the cradle. The fans draw air in through the filter from outside. The filtered air is directed towards the infant or child. The fans may be disposed in any portion of the cradle, for example in the side walls or end walls of the cradle. They may be disposed so that the filtered air flows in a particular direction, for example, from the child or infants head to their feet or vice versa.

A removable support structure for supporting the child or infant within the cavity is provided. The removable support structure may be substantially flat to allow the child or infant to be supported on their back or it may include an undulating surface which allows the child or infant to be supported in a seated position.

The rigid canopy 30 is generally dome-shaped in a closed configuration and formed from a plurality of segments 32. In the current embodiment, the dome-shape canopy 30, and each segment 32, has a substantially arch-shaped cross section.

In the current embodiment, a film is applied to the underside of each segment 32. The film filters ultraviolet radiation. In other embodiments, each segment may be made from or include a material which filters ultraviolet radiation.

Each segment 32 of the canopy 30 is rotatable about a common horizontal axis. When in an open configuration, the majority of segments 32 are nested and are significantly overlapped by at least one other segment 32. When in a closed configuration, the segments 32 create a stepped profile with a portion of a segment being overlapped, or underlapped, by another segment 32. The nested and stepped profile is created as each segment changes in size.

Each segment 32 of the canopy 30 includes a coupling assembly which couples the movement of one segment 32 to that of at least one other segment 32 and an aperture 33 for receiving an axle or drive means. The aperture aligns with the horizontal pivot point.

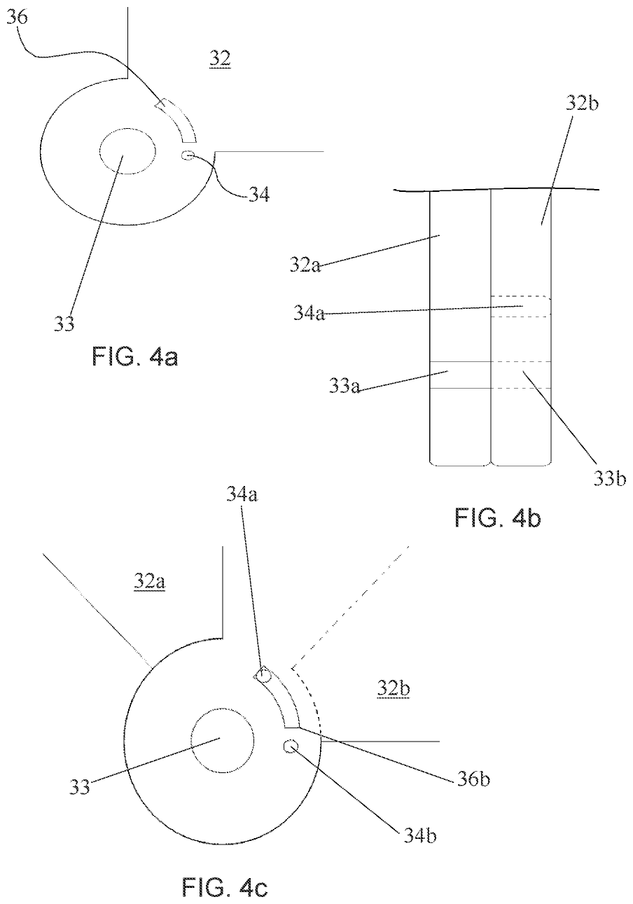

FIGS. 4a, 4b and 4c show one possible embodiment of a coupling assembly. The coupling assembly of each segment 32 includes a coupling pin 34 and a pin receiving slot 36. A first segment 32a is coupled by coupling pin 34a to the receiving slot 36b in the second segment 32b. The receiving slot 36b is an arc of equal radial distance from the aperture 33. By including an elongate slot, it is possible to have the first segment 32a to move independently of the second segment 32b. In Other embodiments there may be any number of segments.

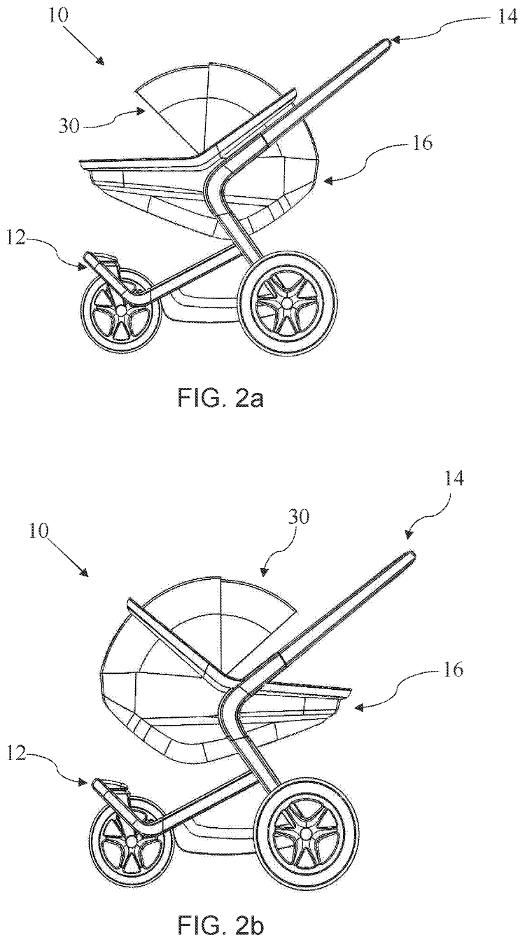

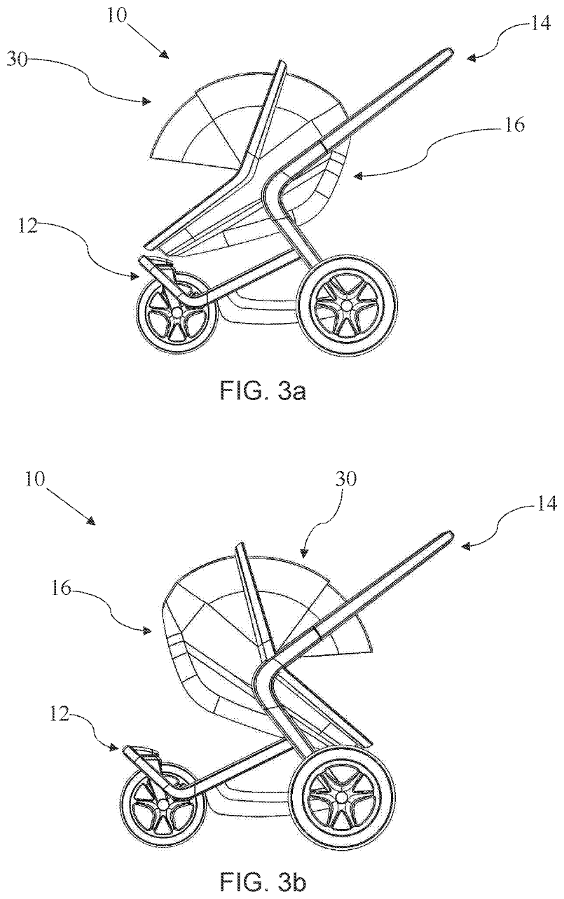

FIGS. 5a & 5b shows an embodiment of a connection assembly, with FIG. 5a showing the connector 38 and FIG. 5b showing a co-locating connector 40. The detachable cradle 16 has two connectors 38 diametrically disposed thereon. The chassis has two co-locating connectors 40 disposed on or in the cradle connection sections 24. The connection assembly allows the cradle 16 to be coupled to the back-frame section 14 in a world-facing configuration (FIGS. 1, 2a and 3a) or a parent-facing configuration (FIGS. 2b and 3b). In the world-facing configuration the cavity and aperture are generally facing in a forward direction away from the operator, allowing the child or infant to view the world. In the parent-facing configuration the cavity and aperture are generally facing in a rearward direction towards the operator, allowing the child or infant to interact with the parent or caregiver.

The connector 38, and co-locating connector 40 also allows the detachable cradle 16 to be rotated about the horizontal axis, this allows the cradle 16 to move between an inclined configuration (FIGS. 3a and 3b) and a reclined configuration (as shown in FIGS. 1, 2a and 2b). The inclined configuration allows for the cradle 16 to be used as a seat while the reclined configuration allows for the cradle to be used for keeping a child or infant in the prone position.

The connection assembly also comprises a locking element to secure the connector and co-locating connector together.

In the current embodiment, the connector 38 is provided by a cylindrical extension 42 extending from the rigid body 28 of the detachable cradle 16. The co-locating connector 40 extends from the cradle connection region 24 and defines a receiving region 44 for vertically receiving the cylindrical extension 42. The cylindrical extension 42 has a gear 46 or other transmission means which interfaces with a transmission means 48 within the co-locating connector 40. The transmission means 48 is connected to an electric motor within the cradle connection means 24. In an alternative embodiment, the electric motor is within the cradle 16. In some embodiments, an electrical connection is provided between the connector 38 and co-locating connector 40, for example there may be a series of conductive rings 50 located on the cylindrical extension 42 and a corresponding series of conductive rings or conductive brushes 52 in the receiving region 44.

In another embodiment, a further electric motor is provided in the cradle connection means 24 which connects with a transmission in the detachable cradle 16 when in either the parent-facing configuration or world-facing configuration. The further electrical motor controls the movement of the canopy between the open and closed configuration. In another embodiment, the further electrical motor and transmission means may both be provided in the detachable cradle 16.

Each cradle connection means 24 includes two illumination means. The first illumination means is forward facing, and the second illumination means is rearward facing. Each illumination means comprises a clear or coloured cover and a light emitting source such as an array of LEDs or incandescent bulbs.

The electrical systems within the carriage 10 are controllable by input means located on the chassis. For example, the illumination means may be connected to an input means in the handle which allows for the level of illumination provided to be controlled. The input means may be a button or switch.

The storage tray 17 is provided in the front-frame section 12 between the two prongs. The storage tray 17 is defined by two walls extending vertically from each prong and a wall extending off vertical between each prong. A base wall is connected to the walls extend from each prong.

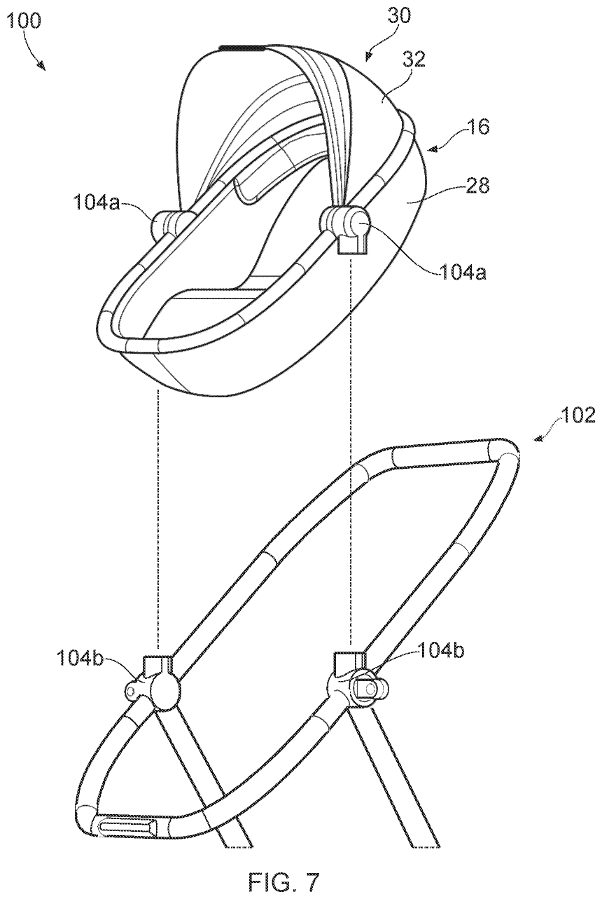

Referring to FIGS. 6, 7, 8a, 8b, 9 and 10, a further embodiment of the carriage is generally indicated at 100. Similar features will maintain the same reference numerals as those used previously. The ground bearing wheel and lower section of the chassis is not shown.

The carriage 100 comprises a foldable chassis formed from a lower-frame section and an upper-frame section 102, a plurality of ground bearing wheels coupled to the chassis, a detachable cradle 16 and a storage tray.

The upper-frame section 102 defines a region for receiving the detachable cradle 16. The cradle 16 is releasably connected to the upper-frame section 102 through two diametrically disposed connector assemblies 104. Each connector assembly 104 comprises a connector 104a disposed on the detachable cradle 16 and a co-locating connector 104b disposed on or in the upper-frame section 102. The connector assemblies 104 allow for the detachable cradle 16 to be placed in two configurations within the receiving region. The first configuration is the world-facing configuration and the second configuration is the parent facing configuration.

In one example, the connector 104a is sized and shaped as to be received in a cavity in the co-locating connector 104b. In another example, the co-locating connector 104b is received in the connector 104a. The connector assemblies 104 provide an electrical connection between the electrical system in the cradle 16 and input means disposed in or on the chassis. In the current embodiment, the electrical connection is provided by a two-piece electrical connector. The first piece comprises a central conductive pin for locating a central conductive recess in the second piece and at least one conductive ring surrounding but electrically isolated from the central conductive pin and/or other conductive rings. The second piece comprises a central conductive recess separated by conductive ring receiving recess. The connector assembly 104 may comprises a locking means to secure the connector 104a to the co-locating connector 104b.

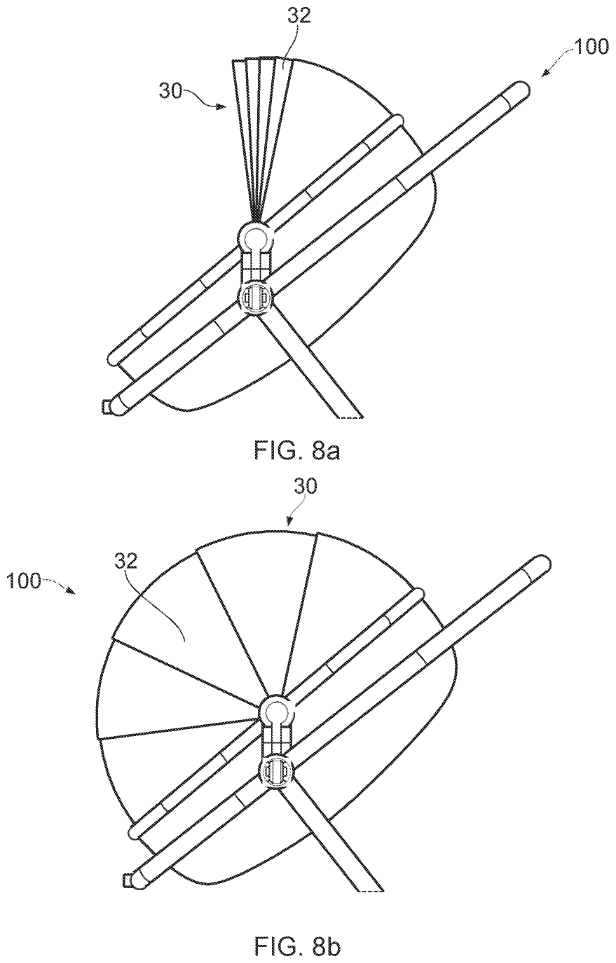

Similar to the embodiments discussed above, the detachable cradle 16 comprises a rigid body 28 defining a cavity for receiving a child or infant, a rigid canopy 30 for covering the cavity. The rigid canopy 30 is movable between an open configuration (See FIG. 8a) in which the cavity is accessible through an aperture in the rigid body and a closed configuration (See FIG. 8b) in which the cavity is not accessible through the aperture in the rigid body.

The cradle 16 includes a housing 106 disposed on an inner surface and located in a region where the head of the infant or child will be located. The housing will extend partially around the inner circumference of the cavity. The housing will enclose the speaker system and enclose or form part of the ventilation system.

The speaker system is connectable to an external device for receiving an audio signal through a wireless means, such as Bluetooth®. The speaker system is controllable by input means located on the carriage, preferably on the chassis. Alternatively, the speaker system may be controllable by the external device. The speaker system produces a limited output to ensure that a decibel level within the region where the head of the infant or child will be located does not reach a level which will cause damage.

The ventilation system comprises an input vent, an output vent connected to the input vent by ducting, a fan and a filter. The output vent is disposed in the housing 106 and directs the flow of filtered air into the region where the head of the infant or child will be located. For example, the vent may direct the flow of filtered air over the head of the baby towards the feet or across the head of the baby. In the current embodiment the input mean is disposed in the outer surface of the cradle 16. In other embodiments, it may be disposed on the internal surface opposite the output vent. The fan is connected to a controller which receives input from input means disposed on the carriage.

The rigid canopy 30 is generally dome-shaped in a closed configuration and formed from a plurality of segments 32. In the current embodiment, the dome-shape canopy 30, and each segment 32, has a substantially arch-shaped cross section. Each segment 32 is rotatable about a common horizontal axis. When in an open configuration (as shown in FIG. 8a), segments 32 are nested within other segments 32 and significantly overlap at least one other segment 32. When in a closed configuration (as shown in FIG. 8b), the segments 32 create a stepped profile and only overlap slightly with other segments 32. The nested and stepped profile is created as each segment changes in size.

Each segment 32 of the canopy 30 includes a coupling assembly (as shown in FIGS. 4a and 4b) which couples the movement of one segment 32 to that of at least one other segment 32 and an aperture 33 for receiving an axle or drive means. The aperture aligns with the horizontal pivot point.

FIG. 9 shows a cross section of the detachable cradle 16 of the carriage 100 in an reclined position. A removable support structure 108 is provided to support a child or infant in a prone position or placed on their back.

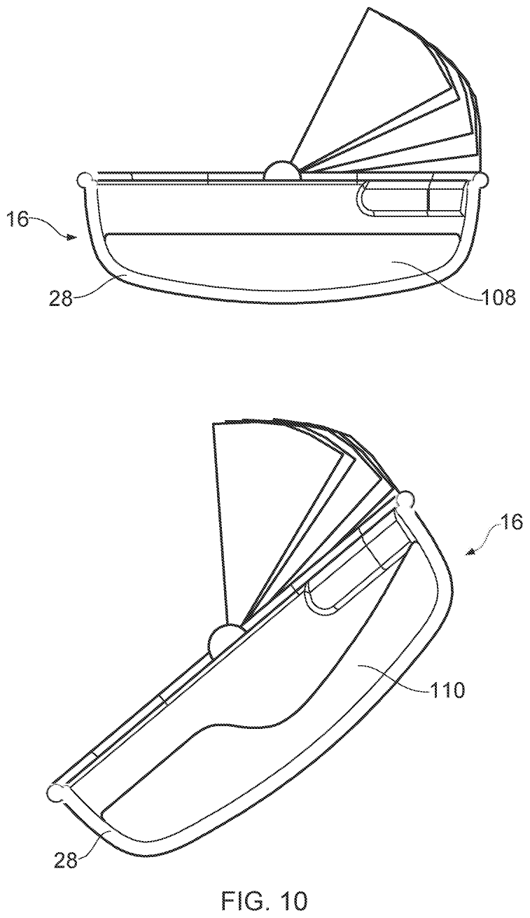

FIG. 10 shows a cross section of the detachable cradle 16 of the carriage 100 in a inclined position. A removable support structure 110 is provided to support a child or infant in a seated position.

FIGS. 11 and 12 show another embodiment of a connection assembly, with FIG. 11 showing a perspective view and FIG. 12 showing a cross-sectional view. The connection assembly comprises a connector 112 disposed on the cradle 16 and a co-locating connector 114 disposed on the chassis. A carriage, such as those discussed in other embodiments, comprise two connector assemblies disposed on a horizontal axis of a chassis. The connection assembly allows for the cradle to be coupled to the chassis in a world-facing configuration or a parent-facing configuration while maintaining the various functions of the carriage.

The connector 112 is provided by a substantially circular surface 116 disposed on or in or extending from the body of the cradle 16, an arcuate wall 118 extending from the edge of the substantially circular surface and a male element 120 extending substantially downwardly from the arcuate wall 118. The arcuate wall 118 extends around substantially half of the periphery of the substantially circular surface, that is, around an upper region of the substantially circular surface.

The co-locating connector 114 is provided by a fixed element 122 disposed on or in the chassis and a rotatable element 124 disposed on the fixed element. The rotatable element 124 comprises a substantially circular wall 126 which substantially corresponds with the substantially circular surface 116 when the connector 112 and co-locating connector 114 are mated, a wall 128 extending from the edge of the circular wall and a recess 130 formed in the wall. The wall 128 may include a weight bearing portion which corresponds with the arcuate wall 118 to bear the weight of the cradle 16. The bearing portion may be recessed to receive the arcuate wall 118.

The recess 130 is sized and shaped to receive the male element 120 when the connector 112 and co-locating connector 114 are mated. For example, the recess may have a substantially rectangular cross section to match a male element which has a substantially rectangular cross section.

In the current embodiment, the male element 120 comprises a plurality of conductive contacts which each correspond with a conductive contact in the recess 130 of the rotatable element 124 when mated. Alternatively or in combination, the circular surface 116 of the connector 112 may have a plurality of conductive rings or arcs which each correspond with a conductive contact on the bearing wall of the rotatable element 124 when mated. The conductive rings or arcs may be similar to those shown in FIG. 5A or FIG. 14.

The conductive contacts disposed on or in the male element 120, and/or the circular surface 116, provide an electrical connection to components, such as motors or fans, within the cradle 16. The conductive contacts disposed on or in the rotatable element 114, either in the recess 130 or the wall 126, provide an electrical connection to at least one power source disposed in or on the chassis and input means disposed on or in the chassis. The power source includes a plurality of electrochemical cells, the cells may be mounted to the rotatable element 124 or the stationary element 122. The electrochemical cells may be rechargeable.

In the current embodiment, one electric motor 132 for moving the cradle 16 between a reclined and inclined position is provided in the chassis. In other embodiments, there may be a further electric motor disposed on the same horizontal axis. A spindle of the electrical motor 132 is coupled to the rotatable element 124 of the co-locating connector 114. The spindle may be coupled fixedly or with a transmission means so that rotation of the spindle causes rotation of the rotatable element 124. This arrangement allows the detachable cradle to be rotated about a horizontal axis from an inclined configuration to a reclined configuration.

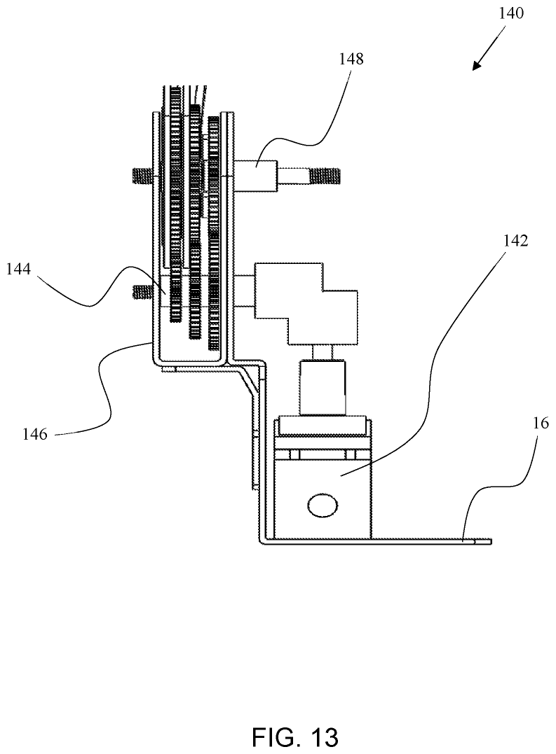

Referring to FIG. 13, a canopy actuating means is indicated generally at 140. Two canopy actuating means may be provided, each being disposed opposite the other on or in a cradle.

An electric motor 142 of the canopy actuating means is disposed on or in the cradle 16, preferably to an inner surface of a body of the cradle. The electric motor 142 is coupled to a first axle 144. The first axle extends through the body of the cradle into a housing 146. A first set of gears are disposed on the first axle, the first set of gears comprise a first gear, a second gear and a third gear. The first gear has a smaller diameter than the second gear which has a smaller diameter than the third gear.

A second axle 148 is disposed within the housing 146 and provides an axis around which each segment of the canopy may rotate. The second axle 148 extends through the housing 146 and body of the cradle 16. A second set of gears are disposed around the second axle, the second set of gears comprise a first gear, a second gear and a third gear. The first gear has a larger diameter than the second gear which has a larger diameter than the third gear.

A first gear pair is provided by the first gear of the first set of gears engaging with the first gear of the second set of gears. A second gear pair is provided by the second gear of the first set of gears engaging with the second gear of the second set of gears. A third gear pair is provided by the third gear of the first set of gears engaging with the third gear of the second set of gears.

Each gear of the second set of gears is disposed on a segment of canopy. Rotation of the first set of gears rotates the second set of gears and causes each segment of the canopy to rotate. Each gear pair may have a different gear ratio so as to allow each segment of the canopy to rotate at a different rate.

The gearing enables the canopy segments to move smoothly and concurrently, with rotation from a single driving axle. The outer, or end canopy, thus moves further and faster than the inner end canopy. The canopy elements may have a similar starting position, or may be slightly spaced as shown in FIG. 8a. The canopy retracts to the starting position when the motor is driven in the other direction. The embodiments described above are provided by way of example only, and various changes and modifications will be apparent to persons skilled in the art without departing from the scope of the present invention as defined by the appended claims.

1. A carriage for transporting a child comprising:
a chassis;
a plurality of ground bearing wheels;
a detachable cradle for supporting a child;
a system for controlling environmental conditions within the cradle, the system having at least one electrical component for altering an environmental condition disposed on or in the cradle and a control interface for controlling the or each electrical component disposed on or in the chassis; and
a connector assembly for detachably mounting the cradle to the chassis in a first configuration wherein the cradle faces away from a carriage operator and a second configuration wherein the cradle faces towards the carriage operator, the connector assembly having a connector disposed on or in the cradle and co-locating connector disposed on or in the chassis, the connector and co-locating connector providing an electrical connection between the or each electrical component and the control interface in either configuration.

2. The carriage of claim 1, wherein the electrical connection also provides connection between a power source disposed on or in the chassis and the or each electrical component in the cradle.

3. The carriage of claim 1, wherein the connector assembly comprises a set first set of conductive connectors and a second set of conductive connectors, wherein each conductive connector of the first set corresponds to one conductive connector of the second set of conductive connectors.

4. The carriage of claim 3, wherein the first set of conductive connectors are formed from a plurality of conductive rings or pads on or extending from a surface of the connector of the connector assembly or co-locating connector of the connector assembly, the second set of conductive connectors are formed from a plurality of biased conductors disposed in a recess or extending from a surface of the connector of the connector assembly or co-locating connector of the connector assembly.

5. The carriage of any preceding claim 1, wherein the system for controlling environmental conditions comprises a protective canopy having a plurality of rigid segments, the canopy being movable between an open configuration and a closed configuration.

6. The carriage of claim 5, wherein the carriage comprises a canopy opening and closing means, wherein the opening and closing means allows the canopy to be moved through a series of configurations between the open configuration and closed configuration.

7. The carriage of claim 1, wherein the carriage comprises a cradle inclining means, wherein the cradle inclining means allows the cradle to be rotated about a horizontal axis of the connector assembly.

8. The carriage of claim 7, wherein the cradle inclining means comprises an electrical motor for rotating the cradle about the horizontal axis, the electrical motor being connected to and controlled from the control interface.

9. The carriage of claim 1, wherein the control interface comprises a wireless module for connecting to an external device, the wireless module receiving data and instructions from the external device.

10. The carriage of claim 1, wherein the carriage further comprises an energy storage device for providing power to the system for controlling the environmental conditions.

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. The carriage of claim 1, wherein the chassis comprises an extendable frame comprising a handle.

26. (canceled)

27. The carriage of claim 1, wherein the system further comprises an air ventilation unit for supplying filtered air to the cradle.

28. The carriage of claim 27, wherein the ventilation unit comprises an air duct having an inlet and outlet, a replaceable filter, and a fan to draw air into the cavity in the cradle through the filter and air duct; wherein the outlet for the air duct is located in a region proximate the intended location of the child or infant.

29. The carriage of claim 1, further comprising a speaker system for controlling the auditory stimulus within the environment of the cradle, the speaker system being connectable to an external signal source.

30. (canceled)

31. The carriage of claim 5, at least one wherein the protective canopy filters ultraviolet light.

32. (canceled)

33. (canceled)

34. (canceled)

35. The carriage of claim 5, wherein the protective canopy in the closed configuration substantially covers at least two thirds of the cradle and in the open configuration substantially covers one third or less of the cradle.

36. (canceled)

37. The cradle for detachably mounting to a carriage for transporting a child or infant, the cradle comprising:
a controllable component for altering an environmental condition disposed on or in the cradle; and
a connector disposed on or in the cradle, the connector is adapted to connect with a co-locating connector disposed on or in the carriage, wherein the controllable component is connectable to a control interface disposed on or in the carriage through connection of connector and co-locating connector.

38. The carriage for transporting a child or infant, the carriage comprising:
a chassis;
a plurality of ground bearing wheels mounted to the chassis;
a control interface disposed on or in the chassis for controlling controllable components disposed on or in a detachable mounted cradle; and
a co-locating connector disposed on or in the chassis, the co-locating connector adapted to connect with a connector disposed on or in the detachable mounted cradle, wherein the control interface is connectable to the controllable component through connection of the co-locating connector and the connector.

39. The cradle of claim 37, wherein the connector is further adapted to detachably mount the cradle to the chassis in a first configuration wherein the cradle faces away from the carriage operator and a second configuration wherein the cradle faces towards the carriage operator, wherein an electrical connection is provided between the control interface and the controllable component through the connection of the co-locating connector and connector in either configuration.

40. The carriage of claim 38, wherein the co-locating connector is further adapted to detachably mount the detachable mounted cradle to the chassis in a first configuration wherein the detachable mounted cradle faces away from the carriage operator and a second configuration wherein the detachable mounted cradle faces towards the carriage operator, wherein an electrical connection is provided between the control interface and the controllable component through the connection of the co-locating connector and connector in either configuration.
